(19) United States
(12) Patent Application Publication
(10) Pub. No.: US 2005/0029697 A1
(43) Pub. Date: Feb. 10, 2005

(54) Method of manufacturing foam from thermoplastic elastomeric material

(75) Inventors: Chun-Hsiung Wu, Tainan (TW); Ruey-Sheng Shih, Tainan (TW)

Correspondence Address: BACON & THOMAS, PLLC, 625 SLATERS LANE, FOURTH FLOOR, ALEXANDRIA, VA, 22314, US

(73) Assignee: MICROCELL COMPOSITE COMPANY, Tainan City (TW)

(21) Appl. No.: 10/824,467

(22) Filed: Apr. 15, 2004

(30) Foreign Application Priority Data
Aug. 4, 2003 (TW) 092121249

(51) Int. Cl. B29C 44/02

(52) U.S. Cl. 264/51; 264/160; 264/321

(57) ABSTRACT

The present invention is to provide a method of manufacturing a foam from a thermoplastic elastomeric material, which comprises the steps of using thermoplastic elastomer as a raw material, adding foaming agent and crosslinking agent into the raw material, kneading and rolling the materials for forming a continuous sheet by means of conventional devices, and cutting the continuous sheet and then conveying to a hot-press mold for foaming.

### FIELD OF THE INVENTION

The present invention relates to a method of manufacturing foam from plastics and more particularly to a method of manufacturing foam from thermoplastic elastomeric material with improved characteristics.

### BACKGROUND OF THE INVENTION

Conventionally, foam materials are classified as a rubber based foam material and a plastic based foam material depending on the raw material. Also, applications of rubber based foam material are different from that of plastic based foam material due to different properties thereof. For example, typically ethylene vinyl acetate (EVA) or a mixture of EVA and polyethylene (PE) is used as the raw material in the foaming process of manufacturing a plastic foam material. As such, the manufactured plastic foam material has advantages of being subject to cold-molding or hot-molding to form products having complicated shape, simple foaming recipe, easy coloring, and being recyclable. The foaming process and applications of products made therefrom are well known. For example, many consumer goods such as shoes, mats, or the like are made from a plastic foam material. Disadvantages thereof, however, are poor elasticity and poor slip resistance.

Moreover, typically a rubber material such as styrene butadiene rubber (SBR) and chloroprene rubber (CR) are used as the raw material in the process of manufacturing a rubber foam material. The manufactured rubber foam material is without the disadvantages associated with the plastic foam material. Further, it has improved elasticity and compression set and slip resistance. However, the receipe of the rubber foam compound are relatively complex. Also, dust is susceptible to generation in the manufacturing process, resulting in an environmental pollution. In addition, it has disadvantages of being difficult of post-molding to form products having complicated shape, and being difficult of recycling the waste material. Such problems have long been existed in the manufacturing of rubber foam material for a long time without solutions.

Thus, it is desirable to provide a method of manufacturing foam having properties of both typical rubber foam and plastic foam materials from a thermoplastic elastomeric material by using the well known manufacturing process in order to improve the properties of foam material and increase applications thereof.

### SUMMARY OF THE INVENTION

A primary object of the present invention is to provide a method of manufacturing a foam from a thermoplastic elastomeric material. The method comprises using thermoplastic elastomer as a raw material, adding foaming agent, crosslinking agent and other additives into the raw material, kneading and rolling these material for forming a continuous sheet by means of conventional devices, and then cutting the continuous sheet with fixed size, finally, conveying these sheet to a hot-press mold for foaming. By utilizing the present invention, the above drawbacks of the prior art can be overcome.

One object of the present invention is to take advantage of conventional EVA based chemical crosslinking process and device for foaming to manufacture a foam from a thermoplastic elastomeric material without having to greatly modifying the prior manufacturing processes.

Another object of the present invention is to provide a produced foam having advantages of good elasticity and being slip resistant as a typical rubber foam material, and simple recipe, easy coloring, easy post-processing, and recycling as a typical plastic foam material.

The above and other objects, features and advantages of the present invention will become apparent from the following detailed description taken with the accompanying drawings.

### BRIEF DESCRIPTION OF THE DRAWING

FIG. 1 is a flow chart illustrating a process according to a preferred embodiment of the invention.

### DETAILED DESCRIPTION OF THE PREFERRED EMBODIMENTS

The invention is directed to a method of manufacturing foam from a thermoplastic elastomeric material. The method comprises the steps of using thermoplastic elastomer as a raw material, adding foaming agent and crosslinking agent into the raw material, kneading and rolling these materials for forming a continuous sheet by means of a conventional device, and then cutting the continnous sheet with fixed size, finally, conveying these sheets to a hot-press mold for foaming by means of a conventional chemical crosslinking process to produce a foam material. The produced foam material of the invention not only has advantages of good elasticity and being slip resistant as a typical rubber foam material but also has advantages of simple recipe, easy coloring, easy post-processing, and recycling as a typical plastic foam material.

In the invention the thermoplastic elastomer as a raw material is selected from a styrenic thermoplastic elastomer such as styrene butadiene styrene (SBS), styrene ethylene butene styrene (SEBS), or styrene isoprene styrene (SIS). In the raw material there are also added other rubber materials, thermoplastic elastomeric materials, or plastic materials in a predetermined weight percentage. Finally, add foaming agent, crosslinking agent, and composing agent in a predetermined weight percentage into the raw material to produce the thermoplastic elastomer of the invention.

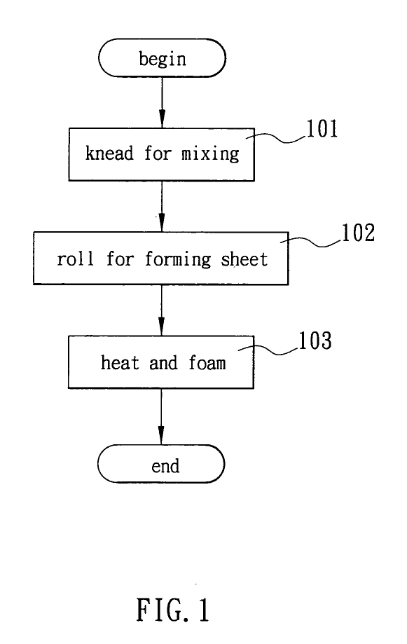

In the process according to a preferred embodiment of the invention conventional kneader, roll mill, and foaming device are used the same as that employed in a conventional EVA based chemical crosslinking process for foaming illustrated in a flow chart of FIG. 1. Kneading, rolling, and foaming steps are performed sequentially on the thermoplastic elastomeric material to be processed and in which in step 101 the invention first pour components of the thermoplastic elastomeric material in a predetermined weight percentage into a kneader, roll mill, and two-roll mill (or Banbury mixer) for uniformly mixing in a temperature ranged from about 90° C. to 130° C.; in step 102 convey the uniformly mixed thermoplastic elastomeric material to the two-roll mill for rolling a plurality of times to form a continuous sheet with required thickness prior to cutting into a plurality of sheet members with a predetermined size by means of an automatic cutter; and in step 103 stack a selected number of sheet members or a selected number of sheet members having a required weight and convey the same to a hot-press mold to heat and foam in a temperature ranged from about 150° C. to 180° C. in a pressure about 90 to 250 kg/cm² wherein a required foam material is formed after heating about 10 to 30 minutes depending on the size and thickness of the hot-press mold.

In the preferred embodiment of the invention the thermoplastic elastomeric material comprises the following components:
(1) Styrenic thermoplastic elastomer: The component is the raw material of the elastomeric material having a weight percentage about 50% to 100% selected from SBS, SEBS, SIS, or styrene ethylene propylene styrene (SEPS).
(2) Chemical foaming agent: The component having a percentage about 1% to 15% of the total weight of the polymeric raw material is selected from a azodicarbonamide chemical foaming agent.
(3) Crosslinking agent: The component having a percentage about 0.05% to 1% of the total weight of the polymeric raw material is selected from a dicumyl peroxide, 2,5-(tert-butylperoxide)-2,5-dimethylhexane or sulfur.

The inventor uses the above components to manufacture a thermoplastic elastomeric foam material in the above manufacturing processes by taking advantage of the conventional chemical crosslinking method for foaming. The foam material has the following advantages after being verified in experimentation:
(1) The invention is able to manufacture a novel foam material having properties of both typical rubber foam and plastic foam materials without having to greatly modifying the prior manufacturing processes by utilizing the conventional chemical crosslinking method and apparatus for foaming.
(2) The produced foam material of the invention has good elasticity and is slip resistant. Also, it is easy of coloring, has no smell of sulfuric rubber, can be recycled, and is wide in applications.
(3) The foam material of the invention has good post-processing capability. As such, it is subject to processing to form products having complicated shapes or patterns. Thus, it is particularly useful in producing products with mark, printing, and adhesive surfaces.

In addition, the invention does not limit the polymeric material as the same as above in practice. Rather, one skilled in the art may add the following components into the thermoplastic elastomeric material for manufacturing foam of the invention therefrom depending on desired capabilities, features, or applications.
(1) Any of other polymeric materials: The component having a percentage about 0% to 50% of the total weight of the polymeric raw material is selected from a styrene butadiene rubber (SBR), polystyrene (PS), ethylene vinyl acetate(EVA), low density polyethylene (LDPE), or ethylene-propylene-diene terpolymer rubber (EPDM) so as to improve the property of foam material for fulfilling the needs.
(2) Accelerator for foaming agent: The component having a percentage about 0% to 3% of the total weight of the polymeric raw material is selected from a zinc oxide or urea for improving and accelerating the foaming.
(3) Any of other additives: The component is selected from oil, zinc stearate or stearate as processing agent, coloring agent as an additive, calcium carbonate, or wood dust for changing the property of the foam material or changing a visual effect thereof.

While the invention has been described by means of specific embodiments, numerous modifications and variations could be made thereto by those skilled in the art without departing from the scope and spirit of the invention set forth in the claims.

1. A method of manufacturing a foam from a thermoplastic elastomeric material, comprising the steps of:
using a thermoplastic elastomer as a raw material;
adding foaming agent and crosslinking agent into the raw material;
kneading and rolling the raw material for forming a continuous sheet by means of conventional devices; and
cutting the continuous sheet and weighing the sheets to a hot-press mold for foaming by means of a conventional chemical crosslinking process to produce a foam material.

2. The method of claim 1, wherein the thermoplastic elastomer is a styrenic thermoplastic elastomer.

3. The method of claim 1, wherein the components of the thermoplastic elastomeric material in a predetermined weight percentage are poured into the conventional devices for uniformly mixing by kneading and rolling in a temperature ranged from about 90° C. to 130° C.

4. The method of claim 3, wherein responsive to uniformly mixing the components of the thermoplastic elastomeric material, the uniformly mixed components of the thermoplastic elastomeric material are transported to a two-roll mill for rolling a predetermined number of times to form a continuous sheet with required thickness prior to cutting into a plurality of sheet members with the predetermined size by means of an automatic cutter.

5. The method of claim 4, further comprising the steps of:
stacking a selected number of sheet members having a required weight; and
cutting the selected number of sheet members to the hot-press mold to heat and foam in a temperature ranged from about 150° C. to 180° C. in a pressure about 90 to 250 kg/cm²,
wherein the foam material is formed after heating a predetermined period of time.

6. The method of claim 5, wherein the thermoplastic elastomer is selected from a styrenic thermoplastic elastomer including a styrene butadiene styrene (SBS), a styrene-ethylene/butene-styrene (SEBS), a styrene isoprene styrene (SIS), and a styrene ethylene propylene styrene (SEPS).

7. The method of claim 6, wherein the styrenic thermoplastic elastomer has a percentage about 50% to 100% of the total weight of the raw material.

8. The method of claim 7, wherein the foaming agent has a percentage about 1% to 15% of the total weight of the raw material.

9. The method of claim 8, wherein the foaming agent is azodicarbonamide chemical foaming agent.

10. The method of claim 9, wherein the crosslinking agent has a percentage about 0.05% to 1% of the total weight of the raw material.

11. The method of claim 10, wherein the crosslinking agent is selected from a dicumyl peroxide, 2,5-(tert-butylperoxide)-2,5-dimethylhexane or sulfur.

12. The method of claim 11, wherein the thermoplastic elastomer further comprises polymeric materials having a percentage about 0% to 50% of the total weight of the raw material.

13. The method of claim 12, wherein the polymeric materials comprise styrene butadiene rubber (SBR), polystyrene (PS), ethylene vinyl acetate (EVA), low density polyethylene (LDPE), and ethylene-propylene-diene terpolymer rubber (EPDM).

14. The method of claim 11, wherein the thermoplastic elastomer further comprises accelerator for foaming agent having a percentage about 0% to 3% of the total weight of the raw material.

15. The method of claim 14, wherein the accelerator for foaming agent is either a zinc oxide or a urea.

16. The method of claim 11, wherein the thermoplastic elastomer further comprises a processing agent selected from stearic acid or zinc stearate.

17. The method of claim 11, wherein the thermoplastic elastomer further comprises an additive including a coloring agent, a calcium carbonate, and wood dust.
